(19) United States
(12) Patent Application Publication
(10) Pub. No.: US 2020/0202400 A1
(43) Pub. Date: Jun. 25, 2020

(54) ARTIFICIAL INTELLIGENCE NEGOTIATION SYSTEM

(71) Applicant: WEMATCH.LIVE R&D LTD, Tel Aviv (IL)

(72) Inventor: Joseph SEROUSSI, Raanana (IL)

(73) Assignee: WEMATCH.LIVE R&D LTD, Tel Aviv (IL)

(21) Appl. No.: 16/630,649

(22) PCT Filed: Jul. 11, 2018
(86) PCT No.: PCT/IB2018/055115

§ 371 Date: Jan. 13, 2020

Related U.S. Application Data
(60) Provisional application No. 62/531,074, filed on Jul. 11, 2017.

(51) Int. Cl. G06Q 30/06; G06N 5/04

(52) U.S. Cl. CPC G06Q 30/0611; G06Q 20/383; G06Q 30/0633; G06N 5/04

(57) ABSTRACT

A system includes a processor and a non-transitory computer readable medium storing instructions executable in the processor. The instructions cause the processor to perform operations which include receiving from a computing device of a first party a request including a first list of parameters associated with a product or a service to be acquired; receiving from a computing device of a second party a response including a second list of parameters associated with a product or a service to be supplied. The operations additionally include determining a correspondence between the first list of parameters and the second list of parameters based on weighted scores; and displaying on third party computing devices information associated with the request, the response, and the correspondence, wherein the identity of the first party and the second party remain anonymous.

### CROSS-REFERENCE TO RELATED APPLICATIONS

This application claims priority from U.S. Provisional Patent Application No. 62/531,074, filed 11 Jul. 2017, which is hereby incorporated in its entirety by reference.

### FIELD OF THE INVENTION

The present invention, in some embodiments thereof, relates to artificial intelligence systems, and, more particularly, but not exclusively, to an artificial intelligence system and method for promoting trade negotiations between parties.

### BACKGROUND OF THE INVENTION

Trading is generally defined as being the transfer of goods and/or services from one person or entity to another, often in exchange for money. Technological advancements, with time, have allowed trading to evolve to a state where goods and/or services may be offered for sale on-line and may be equally purchased on-line through on-line platforms. The physical transfer of the goods and/or services may occur only after the trade has been successfully negotiated on-line by both the selling party and the buying party. Some of these on-line trading platforms maintain both buyers and sellers anonymous in order to prevent their entering into direct negotiation bypassing the intermediary.

One such on-line platform is described in US 2010/0005030 to DePetris et al. which discloses; “A computer program provides a screen-based interface enabling anonymous negotiation between a buyer and a seller. Parties wishing to trade enter values into fields of a screen-based interface, thereby creating a trading interest, and may select from terms associated with each of the fields to augment the trading interest. The parties may also specify counter-party filtering criteria in the trading interest. The computer program then displays to the creator of the trading interest any previously entered trading interests that might result in a trade, and that satisfy the counter-party filtering criteria, if any. The computer program also displays the new trading interest to the creators of the previously entered trading interests. Two of the parties may agree to negotiate using structured messages that maintain their anonymity. The identities of the counter-parties need not be known to each other as, after a trade agreement is reached, a central clearing party becomes the counter-party to each of the parties via a novation”.

Another such on-line platform is described in a U.S. Pat. No. 9,916,618 assigned to EBay Inc. which discloses; “A method, system and computer program product for conducting an online auction of a plurality of heterogeneous items between a plurality of selling and potential purchasing parties. The method includes the steps of accepting an offer in respect of an item, accepting one or more subsequent offers that is/are preferable to a previously accepted offer, and rejecting the previously accepted offer. While the offer/s is/are binding on a party making the offer, acceptance of the offer/s is/are not binding on a party accepting the offer. Classes of “seller strategies”, for offering items to potential purchasing parties, and “buyer strategies”, to decide which offers to accept, are also disclosed. As a result of the interaction of the buyer and seller strategies, the auction mechanism converges to an allocation of items to buyers at particular prices and assists in discovering a free and fair competitive equilibrium price”.

Still another on-line platform is described in U.S. Pat. No. 9,978,069 also assigned to EBay Inc. which discloses; “Embodiments for presenting real-time contact options are described generally herein. The system receives information from a first user about an offered item via a web page and communication preferences for use with a real-time contact option to be presented on the web page, whereby the communication preferences including a first-user-defined real-time contact option presentation condition. The system selectively presents to a second user the information about the offered item and the real-time contact option based on a determination that the first-user-defined real-time contact option presentation condition is satisfied. The system enables the second user to select the real-time contact option. In response to the second user selecting the real-time contact option, the system communicates to the first user a real-time contact request and information identifying the second user”.

### SUMMARY OF THE PRESENT INVENTION

There is provided, in accordance with an embodiment of the present invention, a system including a processor and a non-transitory computer readable medium storing instructions executable in the processor and causing the processor to perform operations including receiving from a computing device of a first party a request including a first list of parameters associated with a product or a service to be acquired, the first list of parameters including a user-defined weighting factor for each of the parameters; receiving from a computing device of a second party a response including a second list of parameters associated with a product or a service to be supplied, the second list of parameters including a user-defined weighting factor for each of the parameters; assigning a system-defined weighting factor to each parameter of the first list of parameters and of the second list of parameters; computing a weighted score for the first list of parameters based on the first party user-defined weighting factors and the system-defined weighting factors; computing a weighted score for the second list of parameters based on the second party user-defined weighting factors and the system-defined weighting factors; determining a correspondence between the first list of parameters and the second list of parameters based on the weighted scores; and displaying on third party computing devices information associated with the request, the response, and the correspondence, wherein the identity of the first party and the second party remain anonymous.

There is further provided, in accordance with an embodiment of the present invention, a non-transitory computer readable medium storing instructions executable in a processor and causing the processor to perform operations including receiving from a computing device of a first party a request including a first list of parameters associated with a product or a service to be acquired, the first list of parameters including a user-defined weighting factor for each of the parameters; receiving from a computing device of a second party a response including a second list of parameters associated with a product or a service to be supplied, the second list of parameters including a user-defined weighting factor for each of the parameters; assigning a system-defined weighting factor to each parameter of the first list of parameters and of the second list of parameters; computing a weighted score for the first list of parameters based on the first party user-defined weighting factors and the system-defined weighting factors; computing a weighted score for the second list of parameters based on the second party user-defined weighting factors and the system-defined weighting factors; determining a correspondence between the first list of parameters and the second list of parameters based on the weighted scores; and displaying on third party computing devices information associated with the request, the response, and the correspondence, wherein the identity of the first party and the second party remain anonymous.

There is additionally provided, in accordance with an embodiment of the present invention, a method including receiving from a computing device of a first party a request including a first list of parameters associated with a product or a service to be acquired, the first list of parameters including a user-defined weighting factor for each of the parameters; receiving from a computing device of a second party a response including a second list of parameters associated with a product or a service to be supplied, the second list of parameters including a user-defined weighting factor for each of the parameters; assigning a system-defined weighting factor to each parameter of the first list of parameters and of the second list of parameters; computing a weighted score for the first list of parameters based on the first party user-defined weighting factors and the system-defined weighting factors; computing a weighted score for the second list of parameters based on the second party user-defined weighting factors and the system-defined weighting factors; determining a correspondence between the first list of parameters and the second list of parameters based on the weighted scores; and displaying on third party computing devices information associated with the request, the response, and the correspondence, wherein the identity of the first party and the second party remain anonymous.

In some embodiments, the first party and the second party user-defined weighting factors are based on personal criteria.

In some embodiments, the system-defined weighting factor is based on historical data stored in a historical data database.

In some embodiments, the historical data includes an accumulation of data associated with system use by all system users.

In some embodiments, the system-defined weighting factor is based on external data stored in an external data database.

In some embodiments, the external data includes an accumulation of data associated with non-system activities and events.

In some embodiments, the system-defined weighting factor is based on user behavioral data stored in a behavioral data database

In some embodiments, the information includes negotiation information between the first party and the second party.

In some embodiments, the information is indicative of a deal reached between the first party and the second party.

In some embodiments, the determining a correspondence includes suggesting a match between the first party and the second party.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 schematically illustrates an exemplary network architecture for an AI negotiation system, according to an embodiment of the present invention;

FIG. 2 schematically illustrates a functional block diagram of the AI negotiation system, according to an embodiment of the present invention;

FIG. 3 schematically illustrates an exemplary state diagram of the AI negotiation system, according to an embodiment of the present invention;

FIG. 4A is an exemplary user interests table which includes both buyers and sellers parameters for processing by a negotiation engine in the AI negotiation system, according to an embodiment of the present invention;

FIG. 4B is a suggestion matching table which shows how the negotiation engine computes weighted scores and determines suggested matches based on the users interests table, according to an embodiment of the present invention;

FIG. 5 is a flow chart showing an exemplary operational method of the AI negotiation system, according to an embodiment of the present invention;

FIG. 6 is an exemplary generalized flow chart of an anonymous negotiation process executed by the AI negotiation system, according to some embodiments of the present invention; and

FIG. 7 schematically illustrates an exemplary display of the GUI of the AI negotiation system, according to an embodiment of the present invention.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE PRESENT INVENTION

In the following detailed description, numerous specific details are set forth in order to provide a thorough understanding of the invention. However, it will be understood by those skilled in the art that the present invention may be practiced without these specific details. In other instances, well-known methods, procedures, and components have not been described in detail so as not to obscure the present invention.

In the following detailed description, the AI negotiation system of the present invention may be described with reference to trading, and with reference to and buyers and sellers. Notwithstanding, the skilled person may realize that the AI negotiation system of the present invention may be used in any type of application which may involve any sort of negotiation between two or more parties and is not limited to use only for trading by buyers and sellers. Some examples of other applications may include contractual negotiations of all sorts, and decision making processes which include negotiating steps.

Applicant has realized that the most difficult aspect of any trade is the negotiation aspect which can either “make or break” a deal. A buyer seeking a product or a service may be faced with one of three situations; (1) to close a deal because the seller is offering exactly what he or she is seeking to buy and the seller's conditions are acceptable to the buyer, (2) to accept what the seller is offering once the seller and/or the buyer have made possible concessions, and (3) to reject the seller's offer altogether regardless of any possible concessions. The Applicant has further realized that existing on-line trading systems generally do not address the negotiating aspect and only serve to provide a platform for buying and selling, in some cases including matching potential buyers and sellers.

Applicant has therefore devised an artificial intelligence (AI) negotiation system which assists a seller and a potential buyer to close a deal by acting as a negotiation intermediary. According to an embodiment of the present invention, the AI negotiation system includes a negotiation engine which in a first stage suggests matching one or more anonymous sellers with one or more anonymous potential buyers. Once a buyer and a seller express an interest in negotiating a deal, the negotiation engine attempts to bring the parties together to close the deal in a second negotiation stage. During the negotiation stage, the negotiation engine may operate iteratively back and forth between the buyer and the seller with updated matching suggestions in an effort to satisfy both buyer and seller needs when possible, or otherwise to enable them to make the necessary concessions to close the deal.

In some embodiments, the matching suggestions (suggested matches) may be based on a weighted score which may be calculated for each potential buyer and for each seller by the negotiation engine. The weighted score may be calculated for a number of user-defined parameters of which the weighted scoring criteria for the parameters may be partially user-defined and partially system-defined. The user-defined parameters which may be considered as “explicit” parameters may include “strict” parameters where the user is not willing to compromise and “loose” parameters where the user may be willing to be flexible. The strict and loose parameters may apply both to buyers and sellers. The user-defined weighted scoring criteria may be based on personal criteria and may be predetermined. The system-defined weighted scoring criteria may be based on system data acquisition and analysis and may include behavioral data associated with the user's past activities in the system, historical data associated with past operations performed by each registered user in the system, and external data which may include any type of information which may be of interest in determining trading conditions, for example, weather information, market information, business information, political information, scientific information, medical information, social media, among other type of information. The data analysis may include use of data analytics and data mining techniques.

In some embodiments, the AI negotiation system may anonymously suggest sellers to anonymous potential buyers based on buyer request. A potential buyer may post a request to the system which may include the explicit parameters and which may be made visible by the system to the related market. Responsively, interested sellers may respond to the request through the AI negotiation system which may suggest (“push”) the sellers to the potential buyers. The AI negotiation system may also make visible the details of what the sellers may provide responsive to the request in an effort to bring the parties to try to improve the conditions in order to bring them to negotiate.

In some embodiments, a potential buyer may evaluate the suggested matches (sellers) and may determine if to negotiate with any one of them, optionally with several suggested matches at the same time. During the negotiation, if a seller partially meets the request of the buyer, the AI negotiation system may suggest to the buyer additional matches which may help complete the buyer's request. Optionally, the system may suggest to the seller in negotiation other potential matches which may help it fulfill the entire buyer's request.

In some embodiments, the AI negotiation system may include a GUI (Graphical Unit Interface) which may allow all users to see the buyers' and sellers' posts, suggested matches including matching details and weighted score. The GUI may additionally allow the users to see the state of each suggested match, including seeing if the potential buyers and sellers have entered into negotiation and whether the negotiations have finalized and a deal has been obtained. This GUI feature may be potentially advantageous as it may allow all users to view the progress of an anonymous negotiation and may coax the negotiating parties into improving their conditions in an attempt to reach an agreement (i.e. either one of the negotiating parties may be threatened by the possibility that another potential buyer may improve the buying conditions or that another seller may improve the selling conditions).

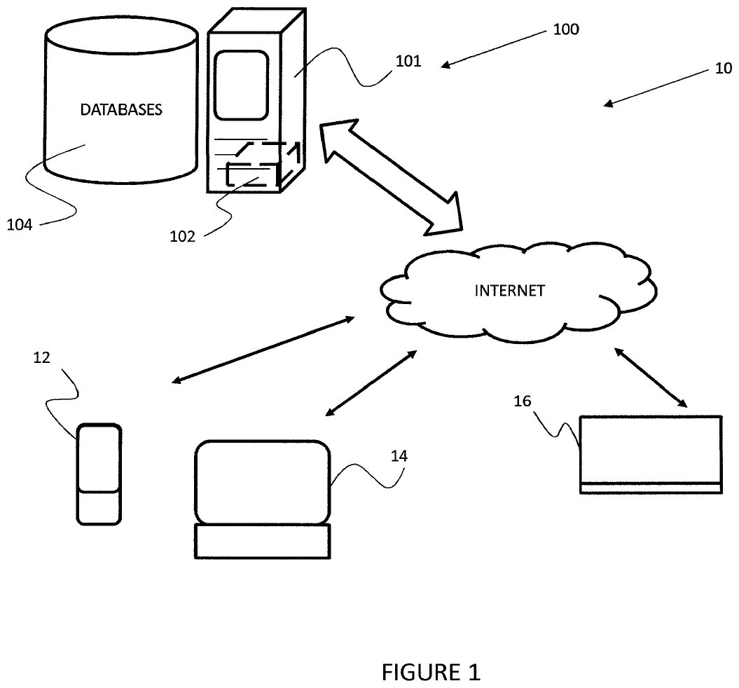

Reference is now made to FIG. 1 which schematically illustrates an exemplary network architecture 10 for the AI negotiation system 100, according to an embodiment of the present invention. Shown is the integration of system 100, which may include a negotiation server 101 with a negotiation engine 102 and a plurality of databases 104, as part of a server based network which may be accessed through the Internet by smartphones 12, PCs 14 and laptops 16 among other suitable computing devices. Smartphones 12 may access system 100 by means of a dedicated application (APP) which may be downloaded to the device over the Internet. PCs 14 and laptops 16 may access system 100 by connecting over the Internet to an online platform (website).

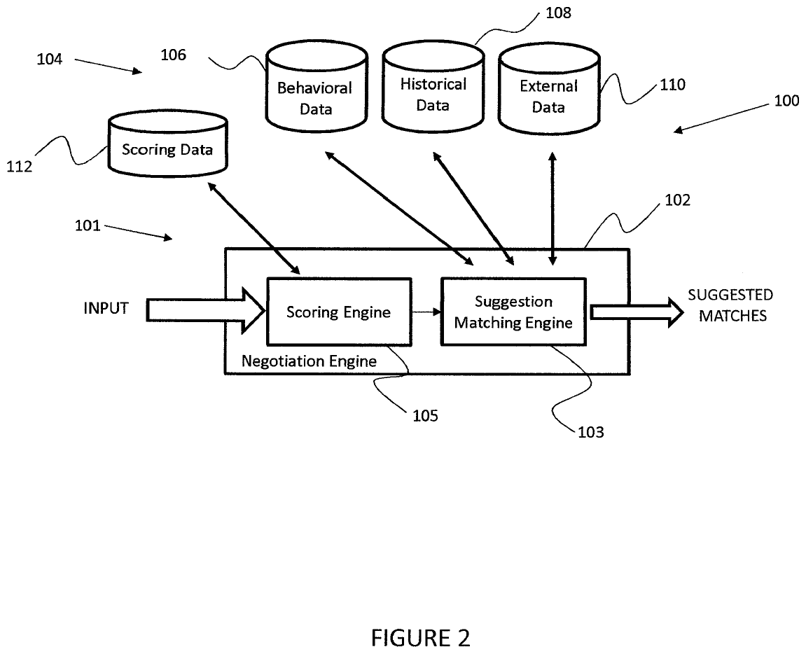

Reference is now also made to FIG. 2 which schematically illustrates a functional block diagram of AI negotiation system 100, according to an embodiment of the present invention. Negotiation engine 102 may include a suggestion matching engine 103 and a scoring engine 105. Databases 104 may include a behavioral data database 106, a historical data database 108, an external data database 110, and a scoring criteria database 112.

Negotiation engine 102 may be responsible for identifying potential parties which partially match a request made by a requesting party and suggesting them to enter into negotiations with the requesting party. Optionally, the potential match party or parties may wholly match a request so there may be no need for negotiating. The request (shown by INPUT), may be responsive to a physical action executed by a person through a computing device, for example devices 12, 14 and 16, or may be automatically generated by a machine and may include use of the computing devices. Responsive to the request, negotiation engine 102 may generate suggested matches between the potential match parties and the requesting party (shown by SUGGESTED MATCHES). The suggested matches may be preferentially ranked according to their weighted score.

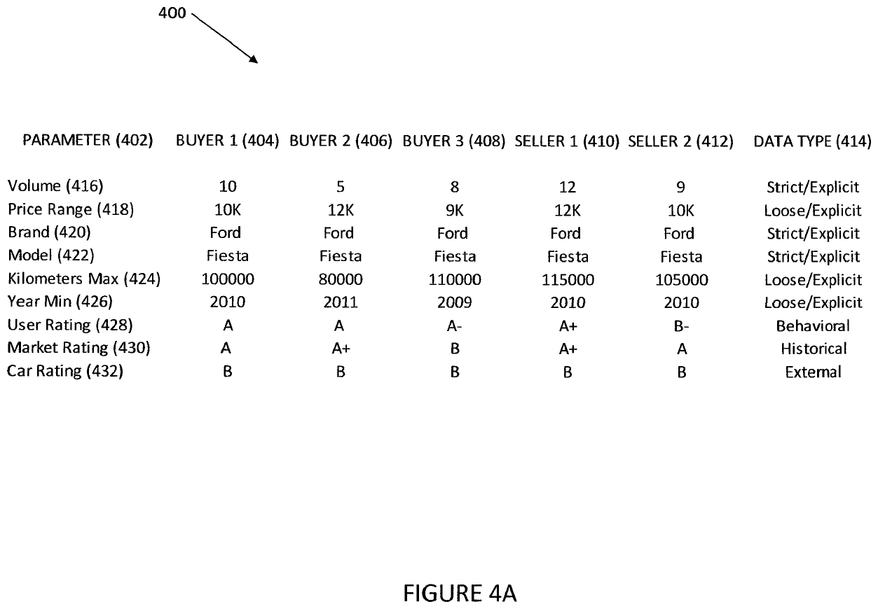

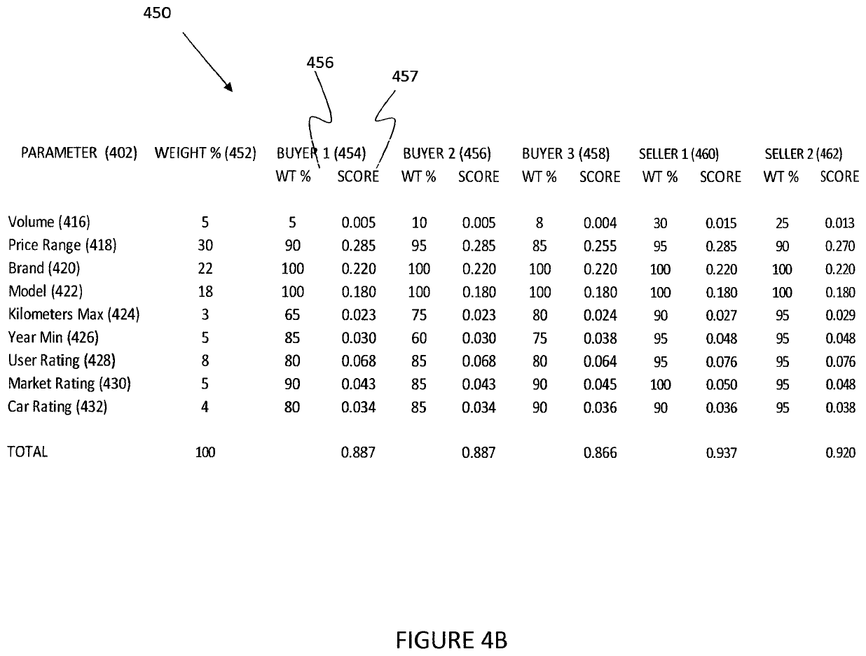

Scoring engine 105 may provide each potential match party with a weighted score representative of the system's assessment of the degree to which the party may meet the request of the requesting party. More details on the operation of scoring engine 105 is provided further on with reference to FIGS. 4A and 4B. Information associated with scoring criteria may be stored in scoring criteria database 112. These may include user-defined weighted scoring criteria and system-defined weighted scoring criteria.

Suggestion matching engine 103 may select potential match parties with the higher score and suggest them to the requesting party. Suggestion matching engine 103 may also consider when selecting the potential match parties' information associated with the requesting party and/or the potential matching parties and which may include behavioral data accumulated in behavioral data database 106 for each registered user. Other information which may be considered in suggesting the matching may be historical data associated with past operations performed by each registered user and accumulated in historical data database 108. Additional information which may be considered is data accumulated in external data database 110. The information in the databases may be continuously or periodically updated.

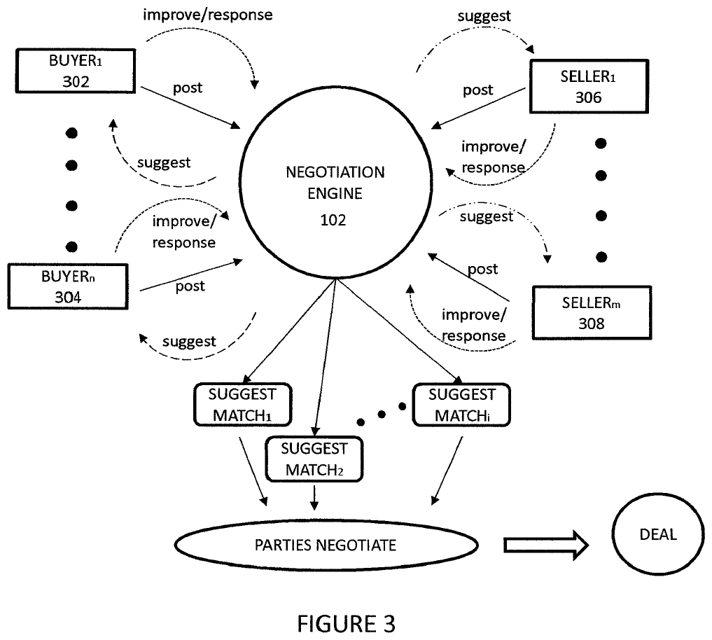

Reference is now made to FIG. 3 which schematically illustrates an exemplary state diagram of AI negotiation system 100, according to an embodiment of the present invention. Shown in the diagram is negotiation engine 102 in interaction with a plurality of buyers, represented by BUYER1 302 to BUYERn 304, and with a plurality of sellers represented by SELLER1 306 to SELLERm 308.

Any one or more of BUYER1 302-BUYERn 304 may post a request which may include all buyer-specified parameters. Negotiation engine 102 may process the request including the buyer specified parameters and make them visible to the market. One or more of SELLER1 306-SELLERm may react to the request and may post a response to the request which may also be made visible to the market. Responsively, negotiation engine 102 may suggest to the respective buyer(s) the responses of the seller(s) in hope that the buyer(s) will respond with an improvement in the conditions in the direction of the seller(s). Optionally, the buyer(s) may respond that there is no interest (e.g. no response). The buyer's or buyers' response, optionally including the improved conditions, may be suggested to the seller(s) by negotiation engine 102 and again may be made visible to the market. The seller(s) may again respond to the buyer(s) improved conditions with an acceptance of the conditions, a rejection of the conditions (e.g. no response), or improved seller conditions. This process may be iterated several times. Negotiation engine 102 may then generate one or more suggested matches, SUGGEST MATCH₁, SUGGEST MATCH₂ . . . SUGGEST MATCHᵢ which may be displayed according to ranking, for example, from best match to worst match, or only the top three matches, among other possible ranking and display options, in order to bring the buyer(s) and seller(s) to negotiate and attempt to reach a deal.

Reference is now made to FIG. 4A which is an exemplary user interests table 400 which includes both buyers and sellers' parameters for processing by negotiation engine 102, according to an embodiment of the present invention. The parameters in table 400 are identified with an automobile solely for exemplary purposes, and the skilled person may readily appreciate that the parameters in table 400 may vary according to the items, products, or services which may be traded and/or negotiated.

Table 400 includes a first column titled PARAMETER (402) listing the types of parameters which are to be posted by the buyers, a second column titled BUYER 1 (404) listing the actual parameter posted by BUYER 1 for each parameter type, a third column titled BUYER 2 (406) listing the actual parameter specified by BUYER 2 for each parameter type, a fourth column titled BUYER 3 (408) listing the actual parameter specified by BUYER 3 for each parameter type, a fifth column titled SELLER 1 (410) listing the actual parameter specified by SELLER 1 for each parameter type, a sixth column titled SELLER 2 (412) listing the actual parameter specified by SELLER 2 for each parameter type, and an optional seventh column DATA TYPE (414) which may be hidden and may list the kind of parameter (user-specified: explicit, strict, loose; system-specified: behavioral, historical, external).

Table 400 additionally includes nine rows with the different types of parameters to be posted. A first row is titled “Volume” (416) and lists for each buyer the number of automobiles the buyer is seeking to buy and for each seller the number of cars the seller has available for sale. A second row is titled “Price Range” (418) and lists for each buyer the approximate price the buyer is seeking to pay and for each seller the price the seller is offering to sell for. A third row is titled “Brand” (420) and lists for each buyer the automobile brand the buyer is seeking to buy and for each seller the automobile brand the seller is offering for sale. A fourth row is titled “Model” (422) and lists for each buyer the automobile model the buyer is seeking and for each seller the automobile brand the seller is offering. A fifth row is titled “Kilometers Max” (424) and lists for each buyer the maximum number of kilometers in the car the buyer is seeking to buy and for each seller the maximum number of kilometers in the car the seller is offering for sale. A sixth row is titled “Year Min” (426) and lists for each buyer the oldest year of car the buyer is seeking to buy and for each seller the oldest year of the car the seller is offering for sale. A seventh row is titled “User Rating” (428) and lists a system rating, optionally qualitative, based on the user's behavioral characteristics using the AI negotiation system according to user data compiled in behavioral data database 106. An eighth row is titled “Market Rating” (430) and lists a system rating, optionally qualitative, based on historical information compiled in the historical data database 108 from other registered users. A ninth row is titled “Car Rating” (430) and lists a system rating, optionally qualitative, based on external car rating information compiled in the external data database 110 from car evaluation reports.

Reference is now made to FIG. 4B which is a suggestion matching table 450 which shows how negotiation engine 102 computes the weighted scores and determines the suggested matches based on users interests table 400, according to an embodiment of the present invention.

Table 450 includes seven main columns, five columns each divided into two subcolumns. A first column is titled “PARAMETER” (402) and lists the same parameter types found in table 400. A second column is titled “WEIGHT %” (452) and lists a system-defined weight factor for each parameter type which may be based on the compiled historical and external data. Optionally, the system-defined weight factor may be replaced by a user-defined weight factor. A third column is titled “BUYER 1” (454) and is divided into two sub-columns, “WT %” (456) which lists a user-defined weight factor for each parameter type and may be based on personal criteria regarding the importance of the parameter, and “SCORE” (458) which lists for each parameter type a weighted score (matching score) determined by multiplying the system-defined weight factor in the second column for each parameter by the user-defined weight factor. A fourth column is titled BUYER 2 (456) and lists the user-defined weight factor and the weighted score for each parameter type of BUYER 2. A fifth column is titled BUYER 3 (458) and lists the user-defined weight factor and the weighted score for each parameter type of BUYER 3. A sixth column is titled SELLER 1 (460) and lists the user-defined weight factor and the weighted score for each parameter type of SELLER 1. A seventh column is titled SELLER 2 (462) and lists the user-defined weight factor and the weighted score for each parameter type of BUYER 2.

Table 450 includes nine rows with similar parameter types as in table 400. Table 450 additionally includes a tenth row which lists a total of the weighted scores computed for each buyer and seller. For example, the weighted score of BUYER 1 is 0.887 (88.7%), of BUYER 2 is 0.887 (88.7%), of BUYER 3 is 0.866 (86.6%), of SELLER 1 is 0.937 (93.7%), and of SELLER 2 is 0.92 (92%).

In some embodiments, the user-defined weight factor and the system-defined weight factor may be stored in scoring database 112. The weighted score may be calculated by scoring engine 105 which may then transfer the results to suggestion matching engine 103 to determine the best matches and generate suggested matches. The suggested matches may be ranked in a preferential order in a list with the suggested matches with the highest matching score at the top and those with the lowest at the bottom. For example, for the example shown in FIGS. 4A and 4B (tables 400 and 450), suggestion matching engine 103 may suggest matches between BUYER 1 and SELLER 2 and/or BUYER 2 and SELLER 2 at the top of the list as the difference between the matching score of these parties is the smallest of all buyers and sellers. The matching score of BUYER 1 and BUYER 2 is 0.887 and that of SELLER 2 is 0.920, a difference of 0.033, whereas the difference between these buyers and SELLER 1 (matching score 0.937) is 0.05. The difference between BUYER 3 (matching score 0.866) and SELLER 1 is 0.071 and compared to SELLER 2 is 0.054. Therefore, suggestion matching engine 103 may generate a matching list which may include a match between BUYER 1 and/or BUYER 2 and SELLER 2 at the top of the list, followed by BUYER 1 and/or BUYER 2 and SELLER 1, followed by BUYER 3 and SELLER 2, and at the bottom BUYER 3 and SELLER 1. Optionally, suggestion matching engine 103 may generate a partial matching list which may include only those suggested matches with the highest matching scores, for example the top 3 suggested matches, or the top 5 suggested matches, among other possibilities which may be user-specified (user selects number of suggested matches to view). Optionally, a matching list is not generated and only the suggested match with the highest matching score is provided.

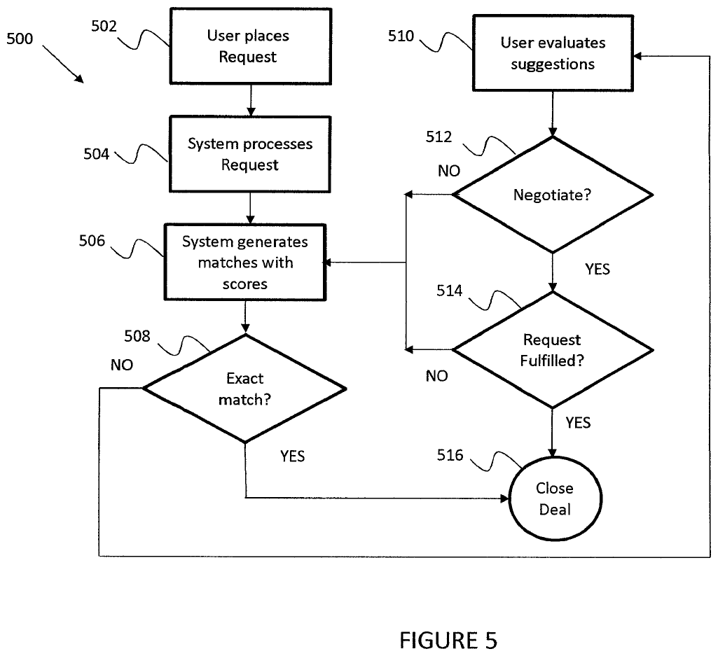

Reference is now made to FIG. 5 which is a flow chart showing an exemplary operational method 500 of the AI negotiation system, according to an embodiment of the present invention. For exemplary purposes, method 500 may be described with reference to AI negotiation system 100 shown in FIGS. 1 and 2. The skilled person may appreciate that the method may be practiced using more or less steps, skipping steps, or with a different sequence of steps.

At step 502, an anonymous requesting party may post a request through AI negotiation system 100. The requesting party may be a buyer seeking to purchase a product. Alternatively, the requesting party may be a person or entity seeking a service or entering into a negotiation procedure such as, for example, a contract negotiation. The request may be posted over the Internet using one of computing devices 12, 14 or 16. The request may include interests associated with user-defined parameters and system-defined parameters, for example as described with respect to table 400 in FIG. 4A.

At step 504, negotiation server 101 may process the request. The request may be open to be viewed by registered users, including anonymous prospective sellers and/or suppliers (potential matching party). Optionally, the request may additionally be viewed by other potential anonymous requesting parties (e.g. potential buyers).

At step 506, negotiation engine 102 may generate suggested matches between the requesting party and the anonymous potential matching party or parties. The suggested matches may include the matching score for each suggested match. The matching scores may be generated by scoring engine 105 and the suggested matches by suggestion matching engine 103, and may include use of the technique described with reference to table 450 in FIG. 4B. The suggested matches may be ranked in a preferential order with matches with the highest matching score at the top of the matching list and those with the lowest at the bottom of the list. Alternatively, a partial matching list may be generated or only matches with the highest matching score may be suggested.

At step 508, negotiation engine 102 may determine whether or not there is an exact match (if a potential matching party fully meets the request of the requesting party). If yes, negotiation engine 102 may connect the requesting party with the matching party and may reveal their identities. Continue to 516 to close the deal. If there is not an exact match, continue to step 510.

At step 510, the requesting party may evaluate the suggested matching parties or party.

At step 512, the requesting party may determine if to negotiate with any one of the potential matching parties (may negotiate with several, optionally at the same time). If the requesting party rejects all the suggestions, the system may return to step 506 and suggest new matches. If the requesting party decides to negotiate with any of the suggested matches continue to step 514.

At step 514, AI negotiation system 100 may evaluate if the potential matching party and the requesting party reach an agreement. If the potential matching party partially meets the request, the system may return to step 506 and suggest to the requesting party additional matches which may help complete the request. Alternatively, the system may suggest to the potential matching party in negotiation other potential matches which may help it complete the request. If the parties do not reach an agreement, the system may return to step 506 and suggest new matches. If the requesting party and the potential matching party reach an agreement, continue to step 516 and the deal may be closed.

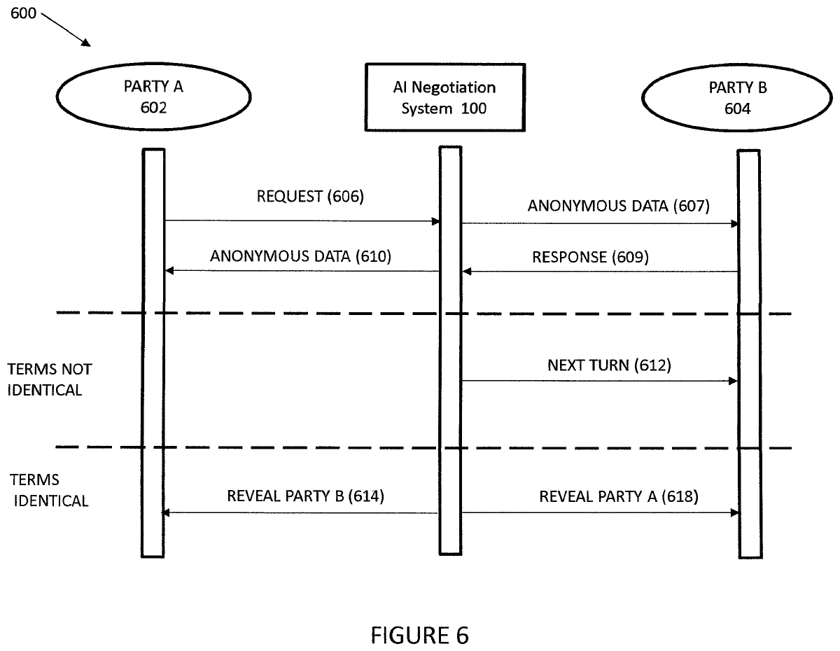

Reference is now made to FIG. 6 which is an exemplary generalized flow chart 600 of an anonymous negotiation process executed by AI negotiation system 100, according to some embodiments of the present invention. As may be viewed from the figure, the transactions are anonymous and the parties are disclosed to one another only after a negotiation has finalized. The transaction flow may be as follows:

Party A 602 (registered user) may post a REQUEST 606 through AI negotiation system 100. AI negotiation system 100 may make the information in the request available to Party B 604 (registered user) as ANONYMOUS DATA 608. Party B 604 may post a RESPONSE 609 through AI negotiation system 100 which is made available to Party A 602. If the terms in RESPONSE 609 identically match those in REQUEST 606, AI negotiation system 100 reveals the identity of Party B 604 to Party A 602 in REVEAL PARTY B 614 and reveals the identity of Party A 602 to Party B 604 in REVEAL PARTY A 618. If the terms in RESPONSE 609 do not identically match those in REQUEST 606, AI negotiation system 100 may initiate a NEXT TURN 612 to attempt to bring Party A 602 and Party B 604 closer together (described in greater detail with reference to FIGS. 3 and 5).

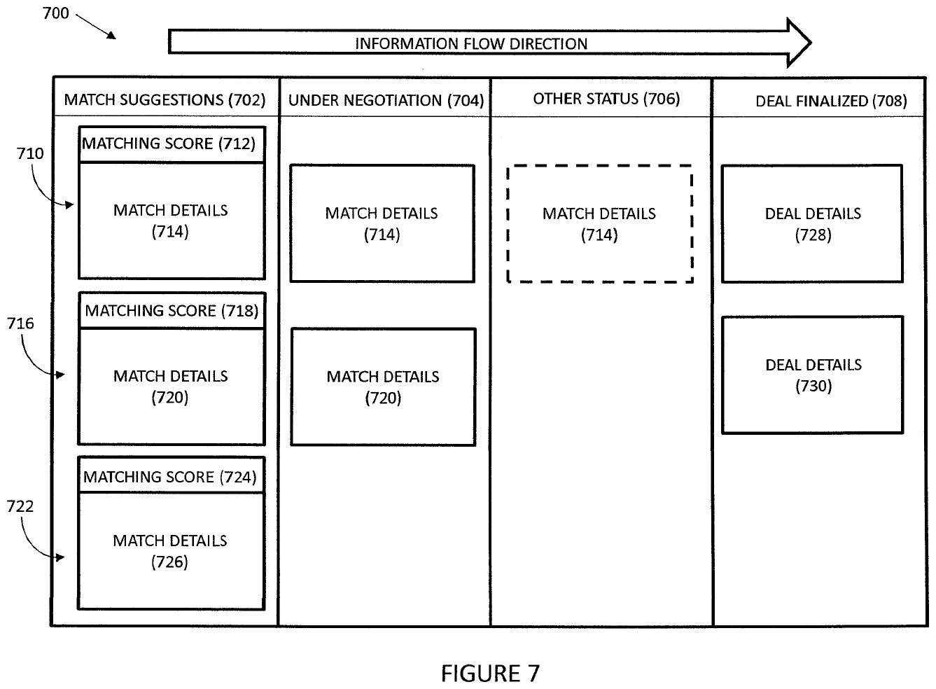

Reference is now made to FIG. 7 which schematically illustrates an exemplary display 700 of the GUI of the AI negotiation system, according to an embodiment of the present invention. GUI display 700 may include a plurality of columns which may include four columns as shown to display the status of transactions. It may be appreciated that multiple negotiations with a same or multiple requesting parties may be displayed and that AI negotiation system 100 may be in different stages of operation for the different requesting parties.

First column titled “MATCH SUGGESTIONS” (702) may display to the users the suggested matches including the matching score and the match details for each suggested match. For example, as shown, suggested match 710 may display a matching score 712 and match details 714, suggested match 716 may display a matching score 718 and match details 720, and suggested match 722 may display a matching score 724 and match details 726. Suggested match 710, 716 and 718 may be related to a same request posted by a requesting party and may be displayed in a preferential ranking order with suggested match 710 having a higher matching score than suggested match 716 and with suggested match 722 having the lowest matching score. Alternatively, suggested matches 710, 716, and/or 722 may have no relationship to one another and each suggested match may be associated with a different request and may optionally have the highest matching score.

Second column titled “UNDER NEGOTIATION” (704) may display to the users those suggested matches from first column (702) which have entered into negotiations with the requesting party including the match details. For example, as shown, suggested match 710 and suggested match 716 have entered into negotiations with the respective requesting parties which may optionally be the same requesting party. Match details 714 of suggested match 710 and match details 720 of suggested match 716 are displayed.

Third column titled “OTHER STATUS” (706) may display to the users those suggested matches, including their match details, whose status may have varied. For example, with respect to suggested match 710, the parties may be no longer negotiating but the deal has not yet been finalized.

Fourth column titled “DEAL FINALIZED” (708) may display the details of the deal following finalization of the negotiations and, if there was an exact match and no negotiations. For example, as shown, suggested match 710 has closed a deal with the requesting party and the deal details 728 are displayed. Similarly, suggested match 716 has closed the deal a requesting party and the deal details 730 are displayed.

Unless specifically stated otherwise, as apparent from the preceding discussions, it is appreciated that, throughout the specification, discussions utilizing terms such as “processing,” “computing,” “calculating,” “determining,” or the like, refer to the action and/or processes of a general purpose computer of any type such as a client/server system, mobile computing devices, smart appliances or similar electronic computing device that manipulates and/or transforms data represented as physical, such as electronic, quantities within the computing system's registers and/or memories into other data similarly represented as physical quantities within the computing system's memories, registers or other such information storage, transmission or di splay devices.

Embodiments of the present invention may include apparatus for performing the operations herein. This apparatus may be specially constructed for the desired purposes, or it may comprise a general-purpose computer selectively activated or reconfigured by a computer program stored in the computer. The resultant apparatus when instructed by software may turn the general purpose computer into inventive elements as discussed herein. The instructions may define the inventive device in operation with the computer platform for which it is desired. Such a computer program may be stored in a computer readable storage medium, such as, but not limited to, any type of disk, including optical disks, magnetic-optical disks, read-only memories (ROMs), volatile and non-volatile memories, random access memories (RAMs), electrically programmable read-only memories (EPROMs), electrically erasable and programmable read only memories (EEPROMs), magnetic or optical cards, Flash memory, disk-on-key or any other type of media suitable for storing electronic instructions and capable of being coupled to a computer system bus.

The processes and displays presented herein are not inherently related to any particular computer or other apparatus. Various general-purpose systems may be used with programs in accordance with the teachings herein, or it may prove convenient to construct a more specialized apparatus to perform the desired method. The desired structure for a variety of these systems will appear from the description below. In addition, embodiments of the present invention are not described with reference to any particular programming language. It will be appreciated that a variety of programming languages may be used to implement the teachings of the invention as described herein.

While certain features of the invention have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A negotiation system comprising:
a processor; and
a non-transitory computer readable medium storing instructions executable in said processor and causing said processor to perform operations comprising:
a) receiving from a computing device of a requesting party a request including a requesting party list of parameters associated with a product or a service to be acquired;
b) broadcasting to computing devices of a plurality of prospective providers said request including said requesting party list of parameters;
c) receiving from one or more of said prospective provider computing devices one or more responses, each response including a prospective provider list of parameters associated with said product or service to be acquired;
d) broadcasting to said requesting party computing device and said plurality of prospective provider computing devices said one or more prospective provider responses including the prospective provider list of parameters;
e) receiving from said requesting party computing device a modified request including a requesting party list of modified parameters associated with said product or service to be acquired;
f) broadcasting to said plurality of prospective provider computing devices said modified requesting party request with said modified list of parameters;
g) receiving from one or more of said prospective provider computing devices one or more responses, each including a prospective party list of modified parameters associated with said product or service to be acquired;
h) computing a weighted score for said requesting party list of modified parameters;
i) computing a weighted score for each one of said prospective provider list of modified parameters;
j) broadcasting said weighted scores from operation h) and from operation i) to said requesting party computing device and to said plurality of prospective provider computing devices; and
k) repeating operations d) to j) until said modified list of parameters in said modified requesting party request matches a modified list of parameters in a modified prospective party response or until the requesting party cancels the request.

2. A system according to claim 1 wherein said instructions further cause said processor to suggest to said requesting party to negotiate with at least one prospective provider when a difference between the computed weighted score for said requesting party's list of modified parameters and the computed weighted score for said at least one prospective provider's list of modified parameters is within a predetermined.

3. A system according to claim 1 wherein said instructions further cause said processor to suggest to at least one of said prospective providers to negotiate with said requesting party when a difference between the computed weighted score for said requesting party's list of modified parameters and the computed weighted score for said at least one prospective provider's list of modified parameters is within a predetermined criteria.

4. A system according to claim 1 wherein an identity of said requesting party and of said one or more prospective providers remains anonymous.

5. A system according to claim 1 wherein said instructions further cause said processor, in operation d), to broadcast said one or more prospective provider responses to other prospective requesting party computing devices.

6. A system according to claim 1 wherein said instructions further cause said processor to broadcast said weighted scores from operation h) and from operation i) in a preferential ranking arrangement.

7. A system according to claim 1 wherein said weighted scores are based on user-defined weighting factors for each parameter in the lists of parameters.

8. (canceled)

9. (canceled)

10. (canceled)

11. A non-transitory computer readable medium for use in negotiations and storing instructions executable in a processor and causing the processor to perform operations comprising:
a) receiving from a computing device of a requesting party a request including a requesting party list of parameters associated with a product or a service to be acquired;
b) broadcasting to computing devices of a plurality of prospective providers said request including said requesting party list of parameters;
c) receiving from one or more of said prospective provider computing devices one or more responses, each response including a prospective provider list of parameters associated with said product or service to be acquired;
d) broadcasting to said requesting party computing device and said plurality of prospective provider computing devices said one or more prospective provider responses including the prospective provider list of parameters;
e) receiving from said requesting party computing device a modified request including a requesting party list of modified parameters associated with said product or service to be acquired;
f) broadcasting to said plurality of prospective provider computing devices said modified requesting party request with said modified list of parameters;
g) receiving from one or more of said prospective provider computing devices one or more responses, each including a prospective party list of modified parameters associated with said product or service to be acquired;
h) computing a weighted score for said requesting party list of modified parameters;
i) computing a weighted score for each one of said prospective provider list of modified parameters;
j) broadcasting said weighted scores from operation h) and from operation i) to said requesting party computing device and to said plurality of prospective provider computing devices; and
k) repeating operations d) to j) until said modified list of parameters in said modified requesting party request matches a modified list of parameters in a modified prospective party response or until the requesting party cancels the request.

12. A storage medium according to claim 11 wherein said instructions further cause said processor to suggest to said requesting party to negotiate with at least one prospective provider when a difference between the computed weighted score for said requesting party's list of modified parameters and the computed weighted score for said at least one prospective provider's list of modified parameters is within a predetermined.

13. A storage medium according to claim 11 wherein said instructions further cause said processor to suggest to one or more of said prospective providers to negotiate with said requesting party when a difference between the computed weighted score for said requesting party's list of modified parameters and the computed weighted score for said at least one prospective provider's list of modified parameters is within a predetermined criteria.

14. A storage medium according to claim 11 wherein an identity of said requesting party and of said one or more prospective providers remains.

15. A storage medium according to claim 11 wherein said instructions further cause said processor, in operation d), to broadcast said one or more prospective provider responses to other prospective requesting party computing devices.

16. A storage medium according to claim 11 wherein said instructions further cause said processor to broadcast said weighted scores from operation h) and from operation i) in a preferential ranking arrangement.

17. A storage medium according to claim 11 wherein said weighted scores are based on user-defined weighting factors for each parameter in the lists of parameters.

18. (canceled)

19. (canceled)

20. (canceled)

21. A negotiation method comprising the steps of:
a) receiving from a computing device of a requesting party a request including a requesting party list of parameters associated with a product or a service to be acquired;
b) broadcasting to computing devices of a plurality of prospective providers said request including said requesting party list of parameters;
c) receiving from one or more of said prospective provider computing devices one or more responses, each response including a prospective provider list of parameters associated with said product or service to be acquired;
d) broadcasting to said requesting party computing device and said plurality of prospective provider computing devices said one or more prospective provider responses including the prospective provider list of parameters;
e) receiving from said requesting party computing device a modified request including a requesting party list of modified parameters associated with said product or service to be acquired,
f) broadcasting to said plurality of prospective provider computing devices said modified requesting party request with said modified list of parameters;
g) receiving from one or more of said prospective provider computing devices one or more responses, each including a prospective party list of modified parameters associated with said product or service to be acquired;
h) computing a weighted score for said requesting party list of modified parameters;
i) computing a weighted score for each one of said prospective provider list of modified parameters;
j) broadcasting said weighted scores from step h) and from step i) to said requesting party computing device and to said plurality of prospective provider computing devices; and
k) repeating steps d) to j) until said modified list of parameters in said modified requesting party request matches a modified list of parameters in a modified prospective party response or until the requesting party cancels the request.

22. A method according to claim 21 further comprising suggesting to said requesting party to negotiate with at least one prospective provider when a difference between the computed weighted score for said requesting party's list of modified parameters and the computed weighted score for said at least one prospective provider's list of modified parameters is within a predetermined criteria.

23. A method according to claim 21 further comprising suggesting to one or more of said prospective providers to negotiate with said requesting party when a difference between the computed weighted score for said requesting party's list of modified parameters and the computed weighted score for said at least one prospective provider's list of modified parameters is within a predetermined criteria.

24. A method according to claim 21 wherein an identity of said requesting party and of said one or more prospective providers remains anonymous.

25. A method according to claim 21 further comprising, in step d), to broadcast said one or more prospective provider responses to other prospective requesting party computing devices.

26. A method according to claim 21 further comprising broadcasting said weighted scores from step h) and from step i) in a preferential ranking arrangement.

27. (canceled)

28. (canceled)

29. (canceled)

30. (canceled)
